(19) United States
(12) Patent Application Publication
(10) Pub. No.: US 2026/0361834 A1
(43) Pub. Date: Nov. 12, 2026

(54) TRANSLATION ACTIVITY INDICATORS DURING A VIRTUAL MEETING

(71) Applicant: Google LLC, Mountain View, CA (US)

(72) Inventors: Maria Josefin Karlsson, Stockholm (SE); Huib Victor Kleinhout, Slattum (NO); Ryan Thomas Fedyk, New York, NY (US); Henrik Porseland, Stockholm (SE); Carolien Postma, Utrecht (NL)

(21) Appl. No.: 19/205,842

(22) Filed: May 12, 2025

(51) Int. Cl. H04N 7/15; G06F 40/58

(52) U.S. Cl. CPC H04N 7/157; G06F 40/58

(57) ABSTRACT

Systems and methods for providing translation activity indicators during a virtual meeting. A virtual meeting user interface (VMUI) is provided during a virtual meeting for presentation on a first user device of a first user participating in the virtual meeting. A notification that playback of a translation of a portion of an audio of a media stream of the virtual meeting for a second user participating in the virtual meeting has begun is received. Upon receiving the first notification, a UI feature notifying the first user that the translation is ongoing is provided for display in the VMUI on the first user device. The duration of the translation is different from a duration of an untranslated audio portion. Upon receiving a second notification that the playback of the translation has ended, removing the UI feature from the VMUI on the first user device.

### TECHNICAL FIELD

Aspects and implementations of the present disclosure relate to providing translation activity indicators during a virtual meeting.

### BACKGROUND

Virtual meetings can take place between multiple participants via a virtual meeting platform. A virtual meeting platform can enable users to connect with other users through a video or an audio-based virtual meeting (e.g., a conference call, or a virtual meeting). The virtual meeting platform can provide tools that allow multiple client devices to connect over a network and share each other's audio data (e.g., a voice of a user recorded via a microphone of a client device) and/or video data (e.g., a video captured by a camera of a client device, or video captured from a screen image of the client device) for efficient communication. To this end, the virtual meeting platform can provide a user interface that includes multiple regions to present the audio and/or video streams of each participating client device and multiple UI features present a variety of tools and notifications during the virtual meeting.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for providing translation activity indicators during virtual meetings. In an implementation, a method includes providing, for presentation during a virtual meeting, a virtual meeting user interface (UI) for presentation on a first user device of a first user participating in the virtual meeting. The method includes receiving a first notification that playback of a translation of a portion of an audio of a media stream of the virtual meeting for the a second user participating in the virtual meeting has begun. Upon receiving the first notification, the method includes providing, for display in the virtual meeting UI on the first user device, a UI feature notifying the first user that the translation of the portion of the audio of the media stream for the second user is ongoing, wherein a duration of the translation of the portion of the audio of the media stream is different from a duration of an untranslated portion of the audio of the media stream. Upon receiving a second notification that the playback of the translation of the portion of the audio of the media stream for the second user has ended, the method includes removing the UI feature from the virtual meeting UI on the first user device.

In some implementations, the UI feature indicates to the first user that the first user is being translated responsive to determining that the portion of the audio corresponds to the first user device.

In some implementations, the method further includes identifying a first language of the untranslated portion of the audio and a second language of the translation of the portion of the audio, wherein the UI feature notifies the first user of at least one of the first language or the second language. In some implementations, the IU feature indicates the duration of the translated portion of the audio of the media stream.

In some implementations, the method further includes responsive to determining that a real-time translation feature of a virtual meeting platform of the virtual meeting is enabled for the virtual meeting, providing, for display in the virtual meeting UI on the first user device, a second UI feature notifying the first user that the real-time translation feature is enabled. The method can further include responsive to determining that the real-time translation feature is enabled and that the translation is active during the virtual meeting, modifying the second UI feature to indicate the translation is active. In some implementations, the method further includes responsive to receiving a user interaction with the second UI feature, providing, for display in the virtual meeting UI on the first user device, a third UI feature indicating one or more languages of the translation of the portion of the audio of the media stream.

In some implementations, the method further includes identifying a user of a plurality of users participating in the virtual meeting, wherein a user device of the user corresponds to the portion of the audio of the media stream. The method further includes identifying a tile of the virtual meeting UI, wherein the tile corresponds to the user, and wherein the UI feature notifying the first user of the translation is provided for display in a UI region overlapping the identified tile.

An aspect of the disclosure provides a system including a memory device and a processing device communicatively coupled to the memory device. The processing device performs the method as described above.

An aspect of the disclosure provides a computer-readable storage medium (which can be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIGS. 2A, 2B, and 2C illustrate examples of virtual meeting user interface (UI) presented on a client device, in accordance with at least one embodiment of the present disclosure.

FIG. 3 is a flow diagram of an example method for providing translation activity indicators during a virtual meeting, in accordance with at least one embodiment of the present disclosure.

FIG. 4A illustrates a schematic block diagram for an artificial intelligence (AI) training subsystem of a virtual meeting platform, in accordance with at least one embodiment of the present disclosure.

FIG. 4B illustrates a schematic block diagram for an AI inference subsystem of a virtual meeting platform, in accordance with at least one embodiment of the present disclosure.

FIG. 5 is a block diagram illustrating an exemplary computer system, in accordance with at least one embodiment of the present disclosure.

### DETAILED DESCRIPTION

Aspects of the present disclosure relate to providing translation activity indicators during virtual meetings. A virtual meeting refers to a real-time communication session, such as a virtual meeting call, also known as a video-based call or video chat, in which participants can connect with multiple additional participants, via a virtual meeting platform, in real-time and be provided with audio and video capabilities. A virtual meeting platform can enable video-based virtual meetings between multiple participants via client devices that are connected over a network and share each other's audio (e.g., voice of a user recorded via a microphone of a client device) and/or video streams (e.g., a video captured by a camera of a client device) during a virtual meeting. In some instances, the virtual meeting platform can enable a significant number of client devices (e.g., up to one hundred or more client devices) to be connected via the virtual meeting.

In some instances, the image-based video stream(s) can depict a user or a group of users that are participating in the virtual meeting. The audio stream(s) can include, in some instances, an audio recording of audio provided by the user or group of users during the virtual meeting. The video streams and/or audio streams can be referred to as media streams. Some existing virtual meeting platforms can provide a virtual meeting user interface (UI) to each client device connected to the virtual meeting, where the virtual meeting UI visually represents the video streams shared over the network in a set of regions in the UI. For example, the video stream of a participant who is speaking to the other participants in the virtual meeting can be visually represented in a designated region in the UI of the virtual meeting platform. Some virtual meeting platforms can display video streams of the participants in a grid in the UI, where the video stream recorded by each participating device is displayed in a tile in the grid.

Some virtual meeting platforms can provide a translation of the audio provided during a virtual meeting. For example, a translation of the audio in one language can be provided to a subset of the participants, while a translation in another language can be provided to another subset of the participants, all while the original, untranslated audio can be provided to a third subset. Thus, when a participant understands the language being spoken, the audio may be being actively translated for other participants. Such virtual meeting platforms can provide translation(s) to a subset of participants during the virtual meeting, while the other participants may not be aware that the translations are being provided to the subset of participants. Without knowledge of the ongoing translations, a participant may inadvertently interrupt the ongoing playback of the translated audio or become confused by pauses in the speaker's delivery that are due to the translation process. The lack of explicit indicators of audio translation can lead to a suboptimal user experience, hindering the fluidity of multilingual conversations. In some instances, the user may be hesitant to participate in the virtual meeting due to confusion caused by unnatural pauses or interruptions during the translation process. This can cause delays for the participants in the meeting, break the flow of the presentation or discussion, and lead to an unnecessary overconsumption of computing resources.

A technical problem arises in virtual meeting platforms that support audio translation when participants are unaware that others are still listening to translated audio after the original speaker has finished. In such scenarios, the lack of visibility into the ongoing translation process can lead to unintentional interruptions, as participants may begin speaking while others are still receiving, playing, and/or processing the translated content. This can result in overlapping audio streams, which not only disrupts the conversational flow but also increases the computational complexity for the virtual meeting platform. For example, the virtual meeting platform system would need to handle multiple simultaneous audio inputs, manage the synchronization of translated and original audio, and/or potentially resolve conflicts between overlapping speech. These challenges can degrade the quality of the meeting experience, cause confusion among participants, and place additional strain on both the server and the client resources due to the need for advanced audio processing, increased bandwidth usage, and more complex user interface management to handle the resulting interruptions.

Aspects of the present disclosure address the above-noted and other deficiencies by providing translation activity indicators during a virtual meeting. Translation activity can refer to the use of a real-time speech-to-speech translation feature during a virtual meeting. The virtual meeting platform hosting the virtual meeting can enable a participant to provide and/or withdraw consent to have their speech translated at any time during the virtual meeting. The virtual meeting platform can also enable a participant to provide and/or withdraw consent to have translation activity indicators of their speech translation be displayed to other participants of the virtual meeting at any time during the virtual meeting.

The translation activity indicators can reflect a status of the real-time speech-to-speech translation feature, which can be native to the virtual meeting platform (e.g., integrated directly into the virtual meeting platform rather than provided by an external system or service). Examples of the status of the real-time speech-to-speech translation feature can be enabled/disabled, active, ongoing translation, and so on. The virtual meeting platform can provide a virtual meeting user interface (UI) that can include clear and intuitive indications to the participants of a virtual meeting to notify them that real-time speech-to-speech translation is enabled and/or actively occurring during the virtual meeting. In some embodiments, the virtual meeting platform can provide the indications using indicator UI features presented on the virtual meeting UI. An indicator UI feature (also referred to herein as an indicator) can refer to a graphical element designed to guide, inform, and/or alert a user. An indicator can be an animation, and/or can use color, shape, motion, and/or position within the UI to convey information, status, or feedback to the user. In some embodiments, the indicator(s) can be auditory (e.g., a beep), haptic (e.g., vibrations), tactile, or any other type of indicator that conveys information, status, or feedback to the user.

The virtual meeting platform can use multiple visual indicators to notify the participants of active and/or ongoing translations. One indicator can be an active speaker tile indicator, which can inform the participants of the virtual meeting that the speaker's audio is actively being translated for others. For example, when a participant is speaking and their audio is being translated for others, the virtual meeting platform can provide an indicator for display on the speaker's tile (e.g., a UI region depicting the speaker) visible to all participants. The active speaker tile indicator can include text such as “Translating from English” or “Translating for others,” for example.

Another indicator can be a speaker notification indicator, which can inform the speaker that their speech is being translated. The virtual meeting platform can provide, for display on the virtual meeting UI of the device of the speaker, the speaker notification indicator to indicate to the speaker that their audio is being translated. The speaker notification indicator can be provided for display only on the virtual meeting UI of the speaker. The speaker notification indicator can include text such as “You are being translated.”

Another indicator can be a global translation status indicator, which can inform all participants of the virtual meeting when real-time translation is enabled and/or active during the virtual meeting. In some implementations, real-time translation is enabled when at least one participant enables the real-time speech-to-speech translation feature native to the virtual meeting platform. In some implementations, real-time translation is active when the speech of the active speaker is being translated for at least one participant during the virtual meeting. In some implementations, the global status indicator can be a persistent or temporary info-ticker style notification. For example, the global status indicator could be a UI element configured to display a sequence of information in a continuous or periodically updated manner. The UI element may comprise a scrollable or animated region within a region of the virtual meeting UI that presents textual or graphical content, such as notifications, messages, or data updates. As an illustrative example, the global translation status indicator can display a message such as “AI is translating in this call” or “Translation is active.”

Another indicator can be a universal translate badge, which the virtual meeting platform can provide for display in the virtual meeting UI when the real-time translation feature is enabled and/or active. The universal translate badge can provide additional information in response to a user interaction. For example, in response to a user hovering over the universal translate badge indicator, the indicator could display the active translation language pairs, for example, “Translating between English and Spanish.”

In some embodiments, the virtual meeting platform can provide to each of the user devices participating in the virtual meeting the current state of the speech-to-speech translation feature and/or of the ongoing translations during the virtual meeting. In some embodiments, the virtual meeting platform can maintain an enablement status (e.g., enabled/disabled) of the speech-to-speech translation feature for each of the user devices of a virtual meeting and/or of the virtual meeting as a whole, and/or an active status (e.g., active/inactive) of the speech-to-speech translation feature for each of the user devices of a virtual meeting and/or of the virtual meeting as a whole. The virtual meeting platform can provide a notification of the enablement status and/or the active status to each of the user devices of the participants of the virtual meeting, e.g., at the beginning of the virtual meeting, when a user device joins the virtual meeting, at certain intervals throughout the virtual meeting, when one of the statuses changes, and/or at any other appropriate time. The virtual meeting platform can also provide a notification to one or more of the user devices participating in the virtual meeting reflecting an ongoing playback of audio translations. For example, the virtual meeting platform can provide a notification indicating that playback of a translation has begun, and another notification indicating that playback of the translation has ended.

In some embodiments, upon receiving a notification from the virtual meeting platform, a user device can identify and display a corresponding indicator in the virtual meeting UI. For example, in response to receiving a notification that playback of a translation has begun for another user participating in the virtual meeting, the user device can display an active speaker tile indicator. If the user is the speaker, the user device can display the speaker notification indicator. As another example, in response to receiving a notification that real-time speech-to-speech translation is active in the call, the user device can display a global translation status indicator. As yet another example, in response to receiving a notification that real-time speech-to-speech translation is enabled and active, the user device can display the universal translate badge indicator.

In some embodiments, the duration of the translation of the audio can be different from the duration of the untranslated audio. The user device can receive a notification of the duration of the translated audio, and can provide a UI feature (or modify an already-displayed UI feature) to indicate the duration of the translated audio. For example, the UI feature can visually represent the progression of the playback of the translated audio, updating dynamically to reflect the elapsed portion of the duration. The UI feature can convey the passage of time through changes in appearance, such as shifting colors, progressing fill level, increasing opacity, a solid line that moves toward a target, a gradually forming border around an already-displayed UI feature, and so on. The visual changes can enable a user to intuitively perceive how much time remains on the playback of the translated audio, either as it is being played on their user device or on another user device participating in the virtual meeting. The indicators can help a user ascertain when to wait before speaking, to allow for the translated audio to finish playback for other participants, and when it is safe to begin speaking, to avoid inadvertently interrupting the playback of the translated audio. Furthermore, the indicators can help provide context to the speaker around potential pauses in responses from other participants, as they may be waiting for playback of the translated audio to finish before speaking.

In some embodiments, the user device can include in the indicator the language of the original audio (e.g., the language that is being translated) and/or the language(s) in which the audio is being translated. For example, the user device can include in the active speaker tile indicator that the audio of the speaker is being translated for them from an identified source language. As another example, the user device can include as part of the universal translate badge indicator that the audio is being translated from the source language to one or more target languages.

In some embodiments, the virtual meeting platform enables multi-source to multi-target translations in a virtual meeting, with various translation indicators provided to prevent participant confusion and delays during the virtual meeting.

Accordingly, aspects of the present disclosure result in a number of technological advantages over previous solutions including, for example, improved overall performance of the virtual meeting platform. In particular, aspects of the present disclosure provide indications of the state of the speech-to-speech translation feature during a virtual meeting, ensuring that all participants of a multilingual virtual meeting are aware of ongoing translations or the potential for active translations. This can result in a more efficient use of resources (e.g., network bandwidth, processing, computational, and/or memory resources) utilized to facilitate the virtual meeting. The indicators can create a more inclusive communication by preventing interruptions and clarifying potential pauses in the conversation flow. By preventing interruptions and clarifying potential pauses in the conversation flow, the virtual meeting becomes more orderly, allowing the virtual meeting platform to optimize the use of computing resources, resulting in lower CPU usage, reduced bandwidth consumption, and a smoother experience for all participants.

Preventing interruptions and clarifying potential pauses in the conversation flow during a virtual meeting can significantly help reduce the consumption of computing resources. For example, when participants avoid interrupting each other, the conversation can proceed in a more orderly and predictable manner. This reduces the likelihood of multiple audio streams overlapping, which is important because virtual meeting platforms process, transmit, and sometimes separate these overlapping signals. Such processing increases the computational load on both the server and the user devices of the participants. Additionally, when only one person speaks at a time, the platform can optimize bandwidth usage by prioritizing a single audio stream, whereas multiple simultaneous speakers require more data to be transmitted and processed, further increasing bandwidth and resource consumption. Interruptions can also cause rapid switching between media streams as the platform tries to display the current speaker, which requires additional processing power and can strain both the server and/or client devices. By preventing interruptions, aspects of the present disclosure enable the virtual meeting platform to optimize the use of computing resources, resulting in lower CPU usage and reduced bandwidth consumption, for example. Aspects of the present disclosure also enhance AI transparency, improve a user's confidence when participating in meetings, and alleviate certain pain points associated with virtual meetings.

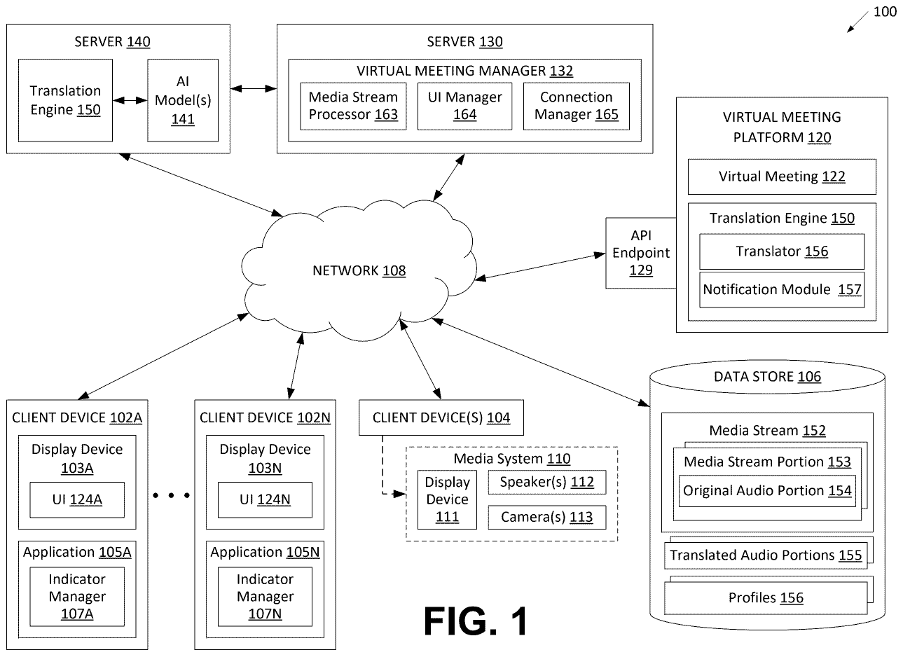

FIG. 1 illustrates an example system architecture 100, in accordance with at least one embodiment of the present disclosure. System architecture 100 (also referred to as “system” herein) includes client devices 102A-102N, one or more client devices 104, virtual meeting platform 120, server 130, server 140, and data store 106, each connected to network 108.

In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 106 is a persistent storage that is capable of storing data as well as data structures to tag, organize, and/or index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. Data store 106 can be hosted by one or more storage devices, such as main memory, magnetic or optical storage-based disks, tapes or hard drives, network-attached storage (NAS), storage area network (SAN), and so forth. In some implementations, data store 106 can be a network-attached file server, while in other implementations data store 106 can be some other type of persistent storage such as an object-oriented database, a relational database, and so forth, that can be hosted by virtual meeting platform 120 or one or more different machines (e.g., the server(s) 130, 140) coupled to the virtual meeting platform 120 via network 108.

In some implementations, data store 106 can include media stream data 152, translation audio portion(s) 155, and/or profiles 156. Media stream(s) 152 can include media stream portion(s) 153 and/or original audio portions(s) 154. Media stream data 152 can include audio data and/or video data, in accordance with implementations described herein. In some implementations, audio and/or video data can include raw data produced by a microphone and/or camera (e.g., connected to a client device 102A-102N, 104), sometimes referred to as audio and/or video feed. In some implementations, audio and/or video data can include processed (e.g., encoded) video and/or audio data, sometimes referred to as audio and/or video streams. Media stream data 152 can store media streams (e.g., audio and/or video streams) received from the client devices 102A-102N, 104, for the virtual meeting platform 120. Moreover, the data store 106 can optionally store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, transcripts, etc.). These documents can be shared with users of the client devices 102A-102N, 104, and/or concurrently editable by the users.

In some implementations, virtual meeting platform 120 can include a virtual meeting 122, and/or a translation engine 150. Virtual meeting platform 120 can enable users of client devices 102A-102N and/or client device(s) 104 to connect with each other via a virtual meeting (e.g., a virtual meeting 122). A virtual meeting refers to a real-time communication session such as a virtual meeting call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Virtual meeting platform 120 can allow a user to join and participate in a virtual meeting with other users of the platform. Implementations of the present disclosure can be implemented with any number of participants connecting via the virtual meeting 122.

In some implementations, virtual meeting platform 120 can include a translation engine 150. In some implementations, at least a portion of the translation engine 150 can be included in client device 102A-102N, 104, servers 130, 140, or other elements of the system 100. The translation engine 150 can include a translator 156 and/or a notification module 157. In some implementations, the translation engine 150 may not include the translator 156, and may access the translator 156 hosted by another element of the system 100.

During a virtual meeting 122, the translation engine 150 can receive (or otherwise identify) media stream data 152. A media stream can refer to a real-time communication of a continuous sequence of encoded data packets representing audio, video, and/or other media content transmitted over a network (e.g., network 108). In some implementations, the media stream 152 may be encapsulated using the Real-time Transport Protocol (RTP), with associated control signaling provided by the Real-time Control Protocol (RTCP) to support synchronization, packet loss recovery, and quality monitoring. Stream parameters, including codec selection, bitrate, and resolution, may be dynamically adapted in response to fluctuating network conditions to maintain low latency and consistent media quality, such as by the connection manager 165 of the virtual meeting manager 132, described below.

In some implementations, the media stream 152 can include one or more media stream portions 153. In some implementations, each media stream portion 153 corresponds to a duration of a portion of the media stream 152 (e.g., a time interval). For example, the media stream portions 153 may represent 5-second intervals of the media stream 152. That is, each media stream portion 153 may include media data for sequential 5-second time intervals of the media stream 152. In some implementations, each media stream portion 153 includes a predetermined number of data packet(s) of the continuous sequence of encoded data packets. In alternative implementations, each media stream portion 153 includes a variable number of data packet(s) of the continuous sequence of encoded data packets.

In some implementations, the duration, length, or size (e.g., number of data packet(s)) of each media stream portion 153 can be variable. For example, the duration of each media stream portion can correspond to a sentence, a phrase, or a particular language. In some implementations, the translation engine 150 can determine the media stream portions 153, according to a particular criterion. In some implementations, a size of the media stream portion 153 is based on data in the media stream 152, such as audio data (represented as original audio portion(s) 154). The size or duration of the original audio portion 154 may correspond to a detected word, phrase, sentence, speaking duration, and/or detected spoken language. For example, the translation engine 150 can identify the spoken language of the media stream 152, and can identify a point during the media stream 152 at which the spoken language changes from one language to another. The translation engine 150 can determine to generate media stream portions 153, each corresponding to a particular spoken language.

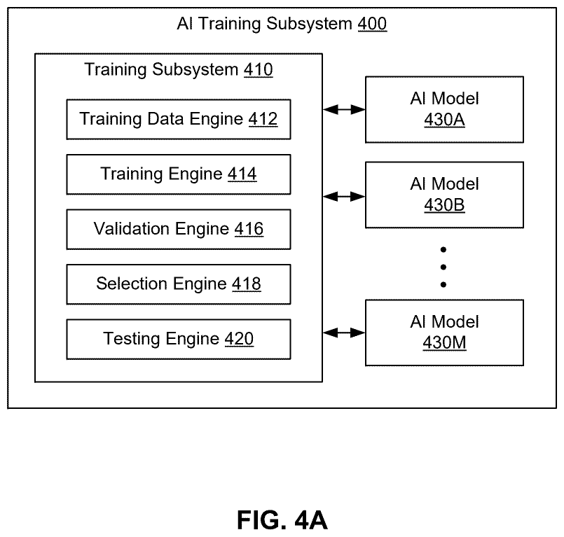

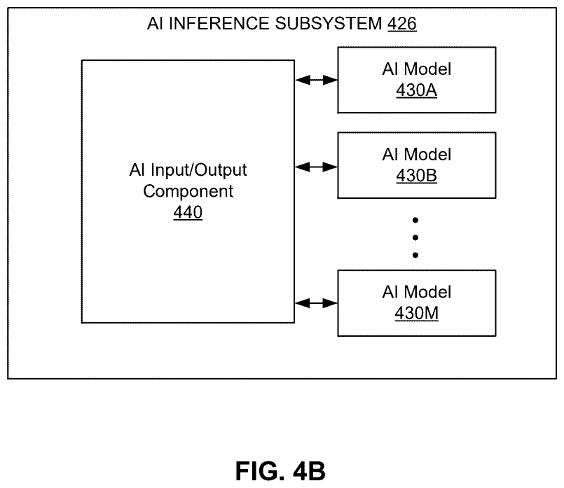

In some implementations, the translation engine 150 can identify the spoken language of the media stream 152 (or a subset thereof) using artificial intelligence. In some implementations, the translation engine 150 can include and/or interface with AI model(s) 141. In some implementations, the AI model(s) 141 can be trained to receive an audio input and provide, as output, an indication of the language of the audio input. In some implementations, the translation engine 150 can provide the audio from at least a subset of media stream 152 as input to AI model(s) 141, and the translation engine 150 can receive, as output from AI model(s) 141, an indication of the spoken language of the audio from at least a subset of media stream 152. In some implementations, the AI model(s) 141 can provide, as output, multiple indications of an identified spoken language. Each indication of an identified spoken language can have a corresponding confidence level representing a probability or degree of certainty that the predicted result (e.g., identified spoken language) is accurate based on the model's learned parameters and input data. In some implementations, the AI model(s) 141 can identify a point in the audio provided as input at which the identified spoken language changes from one language to another. The audio data selection module 151 can generate media stream portion(s) 153 using the identified point in the audio at which the language changes from one language to another. For example, a first media stream portion 153 can include the subset of the media stream that is in the first language, and a second media stream portion 153 can include the subset the media stream that is in the second language. The AI model(s) 141 are further described below, and with respect to FIGS. 4A-4B. The audio data selection module 151 can store the identified spoken language(s), and optionally the corresponding confidence level(s), in data store 106.

In some implementations, the translation engine 150 can separate the original audio portion 154 from the corresponding media stream portion 153, e.g., according to a size, duration, and/or language of the original audio portion 154.

In some implementations, the translation engine 150 can cause the original audio portions 154 to be translated into one or multiple different languages simultaneously. The translation engine 150 can determine the language(s) to translate the original audio portion 154, e.g., using the profiles 156 data, and the translation engine 150 can cause the original audio portion 154 to be translated into those language(s) simultaneously. The translation engine 150 can provide original audio portion(s) 154 to the translator 156. The translator 156 can generate translated audio portion(s) 155 of the original audio portion(s) 154 in multiple languages simultaneously. In some implementations, the translator 156 can include and/or interface with AI model(s) 141. In some implementations, the AI model(s) 141 is trained to receive an audio input in an original language and generate an audio output in a translated language (e.g., target language). In some implementations, the AI model(s) 141 is trained to generate translated audio data (e.g., speech data in a translated language) directly from original audio data (e.g., speech data in an original language) without any speech-to-text based intermediary steps. In some implementations, the AI model 141 is trained to translate one or multiple original languages into multiple translated languages. For example, the AI model 141 can be trained to translate speech in English into speech in Spanish, speech in Russian into speech in French, or speech in Spanish into speech in Italian, French, and English, etc. In some implementations, multiple AI models 141 are trained for each language pairing. For example, a first AI model 141 can be trained to translate speech in English into speech in Spanish (and vice versa), and a second AI model 141 can be trained to translate speech in Russian into speech in French (and vice versa). The AI model(s) 141 are further described below, and with respect to FIGS. 4A-4B. The translated audio portions generated by AI model(s) 141 can be stored as translated audio portions 155 in data store 106.

The translation engine 150 can cause the translated audio portion(s) 155 and/or the original audio portion(s) 154 to be provided to client devices 102A-102N, 104 during the virtual meeting. In some implementations, the translation engine 150 can cause the translated audio portion(s) 55 and/or the original audio portion(s) 154 to begin playback on corresponding client device(s) 102A-102N, 104 during the virtual meeting. The translation engine 150 can determine (or otherwise identify) the duration of each translated audio portion 155 and each original audio portion 154, and can store the duration of each in data store 106. For example, the duration of a translated audio portion 155 can be stored as metadata with the translated audio portion 155.

The notification module 157 can provide notifications to client devices 102A-102N, 104 of the status of the speech-to-speech translation feature of the virtual meeting platform 120 and/or notifications of playback of translations beginning and/or ending on other client devices 102A-102N, 104. In some implementations, in response to the translation engine 150 providing a translated audio portion 155 to a client device 102A-102N, 104, and/or in response to the translation engine 150 causing a translated audio portion 155 to begin playback on a corresponding client device 102A-102N, 104, the notification module 157 can provide a notification to client devices 102A-102N, 104 that playback of an audio translation of the audio portion of media stream 152 has begun. In some implementations, the notification provided by the notification module 157 can indicate the duration of each translated audio portion 155. For example, the notification module 157 can identify the duration of a translated audio portion 155 from metadata stored with translated audio portion 155. In some implementations, the notification provided by the notification module 157 can indicate the source language of the original audio portion 154 and the target language of each translated audio portion(s) 155 corresponding to the original audio portion 154. In some implementations, the notification provided by notification module 157 can indicate which client device(s) 102A-102N is receiving the original audio portion 154, and which client device(s) 102A-102N is receiving which translated audio portion 155. In some implementations, the notification provided by the notification module 157 can indicate which client device 102A-102N provided the original audio portion 154 (e.g., which client device 102A-102N is the active speaker device).

In some implementations, the notification module 157 can identify when playback of each of the translated audio portions 155 corresponding to the original audio portion 154 has ended. In some implementations, the notification module 157 can begin a timer when playback of a translated audio portion 155 begins, and can identify that playback of the translated audio portion 155 has ended when the timer reaches the duration of the corresponding translated audio portion 155. In some implementations, the translation engine 150 can notify the notification module 157 when playback of each translated audio portion 155 has ended. In some implementations, a client device 102A-N, 104 can provide a notification to virtual meeting platform 120 when playback of a translated audio portion 155 has ended. In response to identifying when playback of each of the translated audio portions 155 corresponding to the original audio portion 154 has ended, notification module 157 can send a notification to client devices 102A-102N, 104 indicating that playback of the translated audio portions 155 corresponding to the original audio portion 154 has ended.

In some implementations, the notification module 157 can identify when the speech-to-speech translation feature of the virtual meeting platform 120 has been enabled for the virtual meeting 122. In some implementations, the virtual meeting platform 120 can maintain an enablement status (e.g., enabled/disabled) of the speech-to-speech translation feature for the virtual meeting 122 (e.g., if an administrator has enabled/disabled real-time speech-to-speech translation for the virtual meeting), and/or for each client device 102A-102N participating in the virtual meeting 122. The enablement statuses can be stored in data store 106. The notification module 157 can send a notification to client devices 102A-102N, 104 indicating the status of the speech-to-speech translation feature for the virtual meeting 122 and/or for each client device 102A-102N participating in the virtual meeting 122. In some implementations, the notification module 157 can send a notification to client devices 102A-102N, 104 indicating the status of the speech-to-speech translation feature for the virtual meeting 122 and/or for each client device 102A-102N participating in the virtual meeting 122 at the beginning of the virtual meeting 122, on predetermined schedule (e.g., every few minutes), when a client device 102A-102N, 104 joins or leaves the virtual meeting 122, when a client device 102A-102N, 104 updates their enablement status, when the status is updated the virtual meeting 122 as a whole (e.g., by an administrator), and/or at any other appropriate time.

Client devices 102A-102N can each include computing devices such as personal computers (PCs), laptops, mobile phones, smart phones, tablet computers, netbook computers, wearable devices (e.g., smart watch, smart glasses, etc.), network-connected televisions, smart appliances (e.g., video doorbell), any type of mobile device, etc. In some implementations, client devices 102A-102N can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, client devices 102A-102N can also be referred to as “user devices.” Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio feed) based on the captured audio signal. The audiovisual component can include another device (e.g., a speaker) to output audio data to a user (e.g., a participant of the virtual meeting 122) associated with a particular client device 102A-102N. In some implementations, the audiovisual component can also include an image capture device (e.g., a camera) to capture images and generate video and/or audio data (e.g., a media stream 152) of the captured data of the captured images.

In some implementations, the client devices 102A-102N can implement or include one or more applications (e.g., application 105A-105N) to communicate (e.g., send and receive information) with the virtual meeting platform 120. In some implementations, the client devices 102A-102N can implement a user interface (UI) (e.g., graphical user interfaces (GUIs)), such as a UI 124A-124N) that may be webpages rendered by a web browser and displayed on the client devices 102A-102N in a web browser window. In another implementation, the UI 124A-124N of the client devices 102A-102N may be included in a stand-alone application 105A-105N downloaded to the client devices 102A-102N and natively running on the client devices 102A-102N (also referred to as a “native application” or “native client application” herein). In some implementations, some or all portions of the translation engine 150 can be implemented at the client device 102A-102N.

In some implementations, virtual meeting platform 120 is coupled, via network 108, with one or more client devices 104 that are each associated with a physical conference or meeting room. Client device(s) 104 can include or be coupled to a media system 110 that can include one or more display devices 111, one or more speakers 112, and/or one or more cameras 113. Display device 111 can be, for example, a smart display or a non-smart display (e.g., a display that is not itself configured to connect to network 108). Users that are physically present in the room can use media system 110 rather than their own devices (e.g., client devices 102A-102N) to participate in a virtual meeting, which can include other remote users. For example, the users in the room that participate in the virtual meeting can control the display 111 to show a slide presentation or watch slide presentations of other participants. Sound and/or camera control can similarly be performed. Similar to client devices 102A-102N, client device(s) 104 can generate audio and video data to be streamed to virtual meeting platform 120 (e.g., using one or more microphones, speaker(s) 112 and/or camera(s) 113).

Each client device 102A-102N and/or 104 can include client application 105A-N, which can be a mobile application, a desktop application, a web browser, etc. In some implementations, client application 105A-N can present, on a display device 103-103N of client device 102A-102N, a user interface (UI) (e.g., a UI of the UIs 124A-124N) for users to access virtual meeting platform 120. For example, a user of client device 102A can join and participate in a virtual meeting 122 via a UI 124A presented on the display device 103A by client application 105A. A user can also present a document to participants of the virtual meeting via each of the UIs 124A-124N. Each of the UIs 124A-124N can include multiple regions to present visual items corresponding to video streams of the client devices 102A-102N provided to the server 130, 140, and/or virtual meeting platform 120 for the virtual meeting 122. Each of the UIs 124A-124N can include multiple UI features corresponding to notifications and/or tools provided by the virtual meeting platform 120. For example, a UI feature can present an indicator notifying of the state of speech-to-speech translation during the virtual meeting 122, as described throughout. In some implementations, each UI 124A-124N can display the UI features as instructed by UI manager 164.

In some implementations, application 105A-105N can include an indication manager 107A-107N. Indication manager 107A-107N can provide and/or update one or more indicators. The indicators can be displayed on UI 124A-124N. In some implementations, the indicators are not limited to visual indicators, and can include auditory indicators (e.g., a beep), haptic feedback indicators (e.g., vibrations), and/or any other appropriate type of indicator intended to notify a user of the corresponding client device of translation activity.

In some implementations, indication managers 107A-107N can receive a notification, e.g., from notification module 157, that playback of a translated audio portion 155 has begun. In response to receiving the notification, indication manager 107A-107N can identify one or more dynamic indicators to display and/or modify.

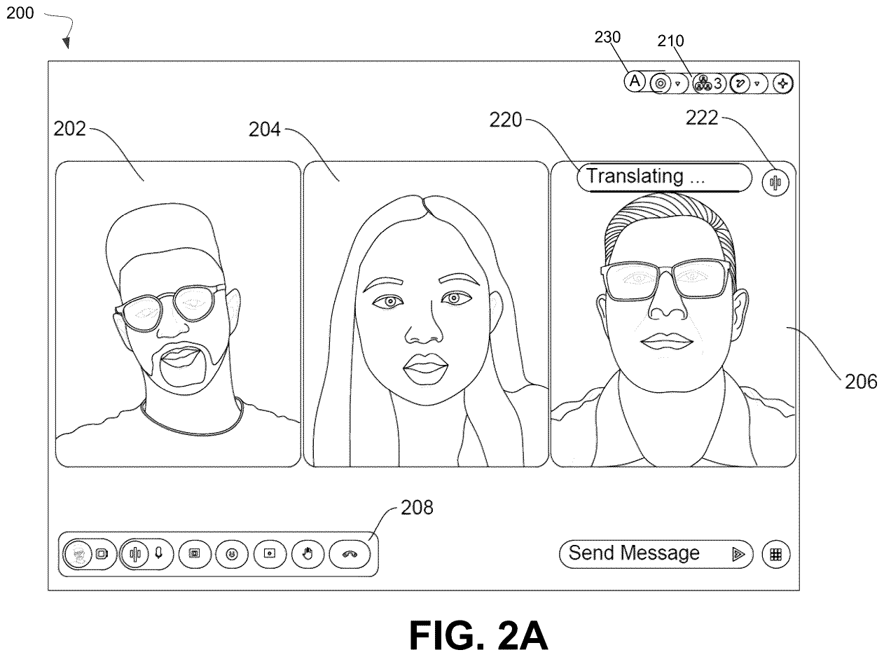

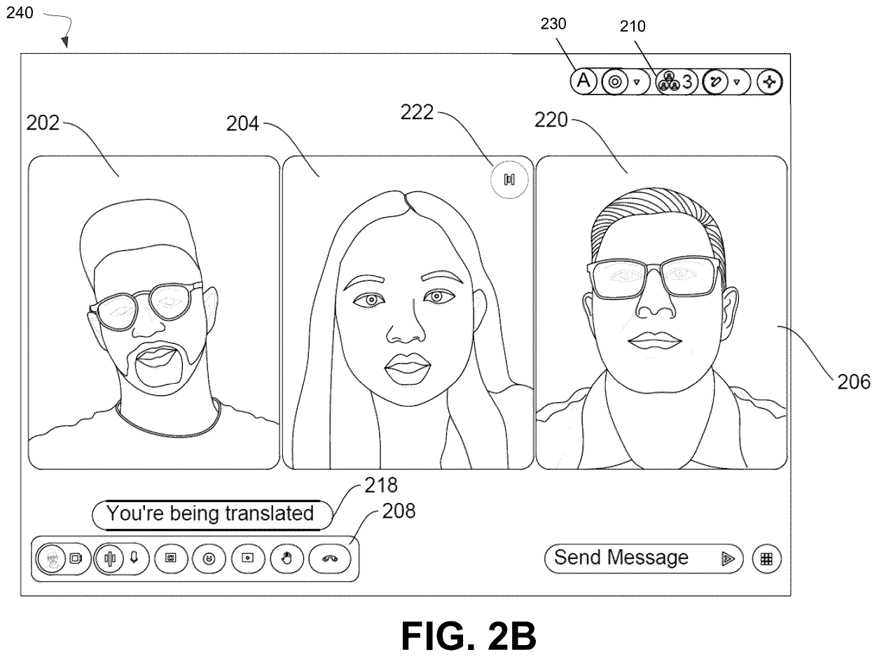

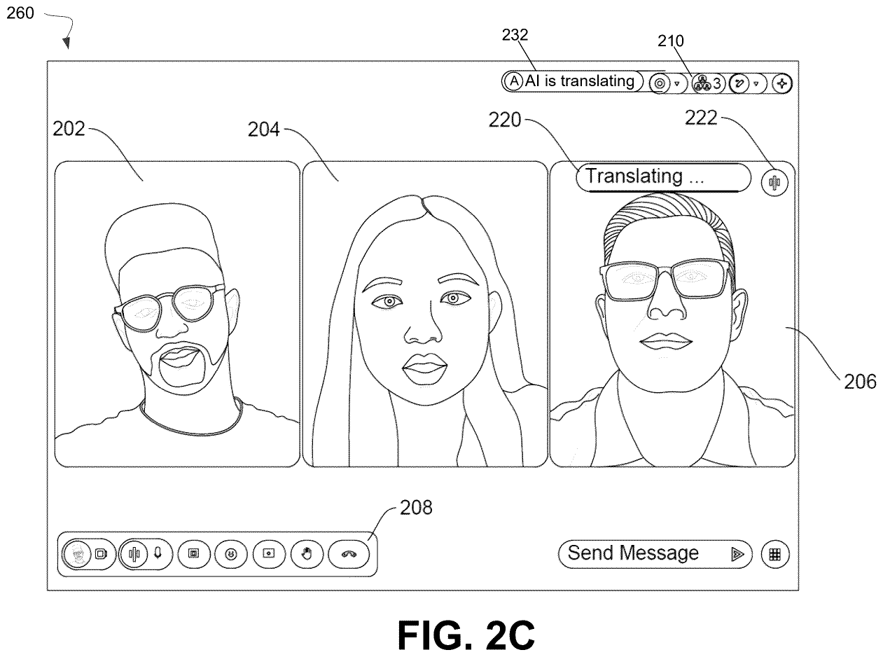

In some implementations, the indicator manager 107A-107N can identify an active speaker tile indicator to display on UI 124A-124N. An example of an active speaker tile indicator is described with respect to FIG. 2A (e.g., UI feature 220 illustrates an example active speaker tile indicator). The active speaker tile indicator can be used to inform the participants of the virtual meeting 122 that the audio of the speaker is being translated. As an illustrative example, the active speaker tile indicator can notify the participants that the original audio is being translated from a source language, or that the original audio is being translated for other participants of the virtual meeting.

In some implementations, the active speaker tile indicator can inform the participants of the virtual meeting 122 that the playback of an audio translation (e.g., a translated audio portion 155) is ongoing. The active speaker tile indicator can be displayed in a region of the UI that overlaps with the tile of the speaker, e.g., as illustrated in FIG. 2A. In some implementations, the active speaker tile indicator is displayed on UI 124A-124N of all the client devices 102A-102N participating in the virtual meeting 122. That is, in response to receiving a notification from notification module 157 that playback of a translated audio portion 155 has begun, the indicator manager 107A-107N of each client device 102A-102N participating in the virtual meeting 122 can identify and provide for display an active speaker tile indicator. In some implementations, the active speaker tile indicator may not be displayed on the UI of the client device 102A-102N of the active speaker. Thus, in response to receiving a notification from notification module 157 that playback of a translated audio portion 155 has begun, the indicator manager 107A-107N of each client device 102A-102N participating in the virtual meeting 122 can first identify whether the translated audio portion 155 corresponds to an original audio portion 154 provided by the corresponding client device 102A-102N, and if not, then identify and provide for display the active speaker tile indicator. In such cases, the indicator manager 107A-107N can identify and provide for display another indicator (e.g., the speaker notification indicator) if the translated audio portion 155 corresponds to an original audio portion 154 provided by the corresponding client device 102A-102N.

In some implementations, the active speaker tile indicator may be different for different participants of the virtual meeting 122. For example, if the participant is listening to a translation of the audio, the active speaker tile indicator may display that the audio is being translated from a source language (e.g., an identify the source language). As another example, if the participant is listening to the original audio (e.g., the audio is not being translated for the participant) but playback of translations is ongoing for other participants, the active speaker tile indicator may display that the audio is being translated for others. Thus, in some implementations, the indicator manager 107A-107N can determine whether the corresponding client device 102A-102N is playing the original audio or a translation of the original audio. In some implementations, the notification received from the notification module 157 can include which client device(s) 102A-102N are receiving which translated audio portion(s) 155 and/or the original audio portion 154. In some implementations, the notification received from the notification module 157 can also indicate the source language of the original audio portion 154 and/or the target language of each translated audio portion 155. In response to determining that the client device 102A-102N is playing a translated audio portion 155, the indicator manager 107A-107N can identify and provide for display an active speaker tile indicator that indicates that the audio is being translated from a source language (e.g., “Translating from English”) on UI 124A-124N. In response to determining that the playback of the translated audio portion 155 playing on the corresponding client device 102A-102N has ended and determining that playback of other translated audio portions 155 playing on other client device(s) 102A-102N has not ended (e.g., is ongoing), the indicator manager 107A-107N can modify the active speaker tile indicator (or otherwise identify and provide for display a second active speaker tile indicator) that indicates that the audio is being translated for others (e.g., “Translating for others”). The indicator manager 107A-107N can keep the active speaker tile indicator visible for all participants of the virtual meeting 122 for as long as playback of at least one translated audio portion 155 is ongoing (e.g., has not ended), thus avoiding unintentional interruptions and/or potential confusion caused by pauses in the conversational flow. In some implementations, the indicator manager 107A-107N can keep the active speaker tile indicator visible for all participants except the active speaker of the virtual meeting 122 for as long as playback of at least one translated audio portion 155 is ongoing (e.g., has not ended).

In some implementations, the indicator manager 107A-107N can receive a notification (e.g., from notification module 157) that playback of all translated audio portions 155 corresponding to an original audio portion 154 have ended. In some implementations, the indicator manager 107A-107N can determine that playback of all translated audio portions 155 corresponding to an original audio portion 154 have ended using the duration of each of the translation audio portions 155. In some implementations, the notification module 157 can send, in addition to or in conjunction with the notification that playback of a translated audio portion 155 has begun, an indication of the duration of the corresponding translated audio portion 155. The indicator manager 107A-107N can start a timer upon receiving the notification, and can determine that playback of the translated audio portion 155 has ended when the timer reaches the duration. In response to determining that playback of all the translated audio portions 155 of the corresponding original audio portion 154 has ended and/or in response to receiving a notification from notification module 157 that playback has ended for all translated audio portions 155, the indicator manager 107A-107N can remove the active speaker tile indicator from the UI of the corresponding client device 102A-102N.

In some implementations, the indicator manager 107A-107N can modify an indicator (e.g., the active speaker tile indicator, the speaker notification indicator) to visually represent the progression of the ongoing playback of the longest translated audio portion 154, updating dynamically to reflect the elapsed portion of the duration and/or to reflect the portion of the duration remaining. The indicator manager 107A-107N can update the indicator to convey the passage of time through changes in appearance, such as shifting colors, progressing fill level, increasing opacity, a solid line that moves toward a target, a gradually forming border around an already-displayed UI feature, and so on.

In some implementations, a user can interact with the active speaker tile indicator, e.g., by clicking on or hovering over the active speaker tile indicator. In response to receiving a user interaction with the active speaker tile indicator, the indicator manager 107A-107N can provide additional options regarding the speech-to-speech translation feature during the virtual meeting 122. For example, the indicator manager 107A-107N can provide an option to stop the translation, to start a translation, to change translation language preferences, and so on.

In some implementations, the indicator manager 107A-107N can identify a speaker notification indicator to display on UI 124A-124N. An example of a speaker notification indicator is described with respect to FIG. 2B (e.g., UI feature 218 illustrates an example speaker notification indicator). The speaker notification indicator can be used to inform the speaker that their audio is being translated. In some implementations, the speaker notification indicator can be displayed in a non-obtrusive region of the UI, to avoid distracting the speaker. In some implementations, the speaker notification indicator can be displayed near a tool bar or peninsula of the UI. In some implementations, the speaker notification indicator can be displayed in a region that overlaps the self-view tile of the speaker.

In some implementations, in response to receiving a notification from notification module 157 that playback of a translated audio portion 155 has begun, the indicator manager 107A-107N can determine whether the translated audio portion 155 corresponds to an original audio portion 154 provided by (or generated from) the corresponding client device 102A-102N. In some implementations, the notification received from the notification module 157 can include an indication of the client device 102A-102N that provided the original audio portion 154. In response to determining that the playback of a translated audio portion 155 corresponds to an original audio portion 154 provided by (or generated from) the corresponding client device 102A-102N, the indicator manager 107A-107N may identify and provide for display a speaker notification indicator. In some implementations, the indicator manager 107A-107N can display the speaker notification indicator for as long as playback of at least one translated audio portion 155 is ongoing (e.g., has not ended). In some implementations, the speaker notification indicator can display text such as “You are being translated.” In response to determining that playback of all the translated audio portions 155 corresponding to the original audio portion 154 has ended, the indicator manager 107A-107N can remove the speaker notification indicator from the UI.

In some implementations, the indicator manager 107A-107N can identify a global translation status indicator to display and/or update on UI 124A-124N. An example of a global translation status indicator is described with respect to FIG. 2C (e.g., UI feature 232 illustrates an example global translation status indicator). In some implementations, the global translation status indicator can be an info-ticker style (or similar style) indicator that informs all participants when real-time translation is active and/or enabled during the virtual meeting.

In some implementations, the global translation status indicator can be always visible on the UI, e.g., on a peninsula 210 as illustrated in FIG. 2C. In some implementations, the global translation status indicator can be greyed out when speech-to-speech translation is disabled for the virtual meeting 122, and can be in color when speech-to-speech translation is enabled for the virtual meeting 122 and/or enabled for the participant. In some implementations, the global status indicator can be displayed in color when speech-to-speech translation is enabled for the virtual meeting 122 and disabled for the participant. In some implementations, the global translation status indicator can be visible on the UI only when speech-to-speech translation is enabled for the virtual meeting 122 and/or enabled for the participant. In some implementations, the global translation status indicator can display text such as “AI is translating in this call” or “Translation is active.” In some implementations, the indicator manager 107A-107N can receive a notification from notification manager 157 that the speech-to-speech translation feature has been enabled for the virtual meeting 122 (e.g., an administrator of the virtual meeting 122 has enabled speech-to-speech translation for the virtual meeting, and/or a participant of the virtual meeting 122 has enabled speech-to-speech translation). In response to receiving the notification, the indicator manager 107A-107N can identify and provide for display (and/or modify an already displayed) global translation status indicator. In some implementations, in response to receiving a notification that speech-to-speech translation feature has been disabled for the virtual meeting 122, the indicator manager 107A-107N can remove (or modify) the global translation status indicator to reflect that translation is not active.

In some implementations, the indicator manager 107A-107N can identify a universal translate badge indicator to display and/or update on UI 124A-124N. An example of a universal translate badge indicator is described with respect to FIGS. 2A,2B (e.g., UI feature 230 illustrates an example universal translate badge indicator).

In some implementations, the universal translate badge indicator can be always visible on the UI, e.g., on a peninsula 210 as illustrated in FIGS. 2A,2B. In some implementations, the universal translate badge indicator can be greyed out when speech-to-speech translation is disabled for the virtual meeting 122 and/or disabled for the participant, and can be in color when speech-to-speech translation is enabled for the virtual meeting 122 and/or enabled for the participant. In some implementations, the universal translate badge indicator can be in color when the speech-to-speech translation is enabled for the virtual meeting 122 and disabled for the participant. In some implementations, the universal translate badge indicator can be visible on the UI only when speech-to-speech translation is enabled for the virtual meeting 122 and/or enabled for the participant. In some embodiments, the universal translate badge indicator can be visible on the UI when there is a language mismatch. For example, the translation engine 150 can compare the language preferences in profile data 156 of each participant of the virtual meeting 122 to the identified spoken language of the active speaker, and can determine there is language mismatch if one of the participants does not have the identified spoken language listed as a language they understand in their profile data 156. In response to identifying a language mismatch, the notification manager 157 can send a notification indicating the mismatch to one, some or all of the client devices 102A-102N participating in the virtual meeting 122. For example, the notification manager 157 can send a notification indicating the mismatch to the client device of the participant that does not have the identified spoken language listed as a language they understand in their profile data 156, to notify the user that speech-to-speech translation is available. The indicator manager 107A-107N, in response to receiving such a notification, can identify and provide for display a universal translate badge. The universal translate badge can be an non-active badge (e.g., greyed out), and in response receiving a user interaction with the badge (e.g., in response to the user hovering over the badge), the indicator manager 107A-107N can expand to the badge to display a message (e.g., “Use AI to translate this call”), and/or can provide an additional UI feature to enable the participant to enable speech-to-speech translation. In some implementations, the indicator manager 107A-107N can provide an active universal translate badge (e.g., in color) when speech-to-speech translation is enabled for the virtual meeting 122 (e.g., by one or more participants of the virtual meeting 122).

In some implementations, the indicator manager 107A-107N can receive a notification from notification manager 157 that the speech-to-speech translation feature has been enabled for the virtual meeting 122 (e.g., an administrator of the virtual meeting 122 has enabled speech-to-speech translation for the virtual meeting, and/or a participant of the virtual meeting 122 has enabled speech-to-speech translation). In response to receiving the notification, the indicator manager 107A-107N can identify and provide for display (and/or modify an already displayed) universal translate badge indicator. In some implementations, in response to receiving a notification that speech-to-speech translation feature has been disabled for the virtual meeting 122, the indicator manager 107A-107N can remove (or modify) the universal translate badge indicator to reflect that translation is disabled.

In some implementations, a user of a respective client device 102A-102N can interact with an indicator (e.g., with the universal translate badge indicator, and/or with the global status indicator). An interaction can be clicking on the indicator (e.g., clicking on the UI feature indicator displayed on the UI), and/or hovering a cursor over the indicator. The indicator manager 107A-107N can modify the UI 124A-124N in response to receiving an interaction with the indicator. In some implementations, hovering over the indicator (e.g., the universal translate badge indicator) can display an option to enable speech-to-speech translation, an option to establish language preferences (e.g., select which in language(s) the participants wants to hear the original audio and in which language the participant wants the original audio to be translated into), etc. As an illustrative example, if the participant has not enabled speech-to-speech translation for their audio during the virtual meeting but speech-to-speech translation has been enabled for the virtual meeting (e.g., by an administrator), hovering over the universal translate badge indicator can display an option for the participant to enable speech-to-speech translation, e.g., by displaying text such as “Use AI to translate this call” or “AI is translating in this call. Let AI translate you for others” or “AI can translate what you say for others in the call” and providing an option to continue to enable speech-to-speech translation. In some implementations, the indicator manager 107A-107N can determine that speech-to-speech translation has been enabled for the virtual meeting 122 and/or by participants of the virtual meeting 122, but that the speech-to-speech translation is not available for the corresponding client device 102A-102N. Speech-to-speech translation may not be available for a client device 102A-102N for any number of reasons, such as if it is geo-fenced, if the user of the client device 102A-102N is anonymous, if the user of the client device 102A-102N is a client device, if the user of the client device 102A-102N is age restricted (e.g., of the age of the user as stored in profile data 156 does not satisfy the jurisdiction's minimum age requirements for speech-to-speech translation), and so on. In such cases, the indicator manager 107A-107N may display, in response to a user interaction with the universal translate badge), text such as “Speech translation is not available for you, but AI may be translating for others in the call.”

In some implementations, in response to receiving a user interaction with the indicator (e.g., in response to a user hovering over the universal translate badge indicator), the indicator manager 107A-107N can reveal the active translation language pairs. For example, the indicator manager 107A-107N can provide for display under the universal translate badge indicator (or otherwise modify the universal translate badge indicator) text such as “AI is translating between English and Spanish.”

In some implementations, the indicator manager 107A-107N can identify an non-visual indicator associated with one of the above-mentioned (or other) indicators, and can cause the non-visual indicator to be implemented on the corresponding client device 102A-102N. For example, the indicator manager 107A-107N can cause the corresponding client device 102A-102N to beep or vibrate when playback of a translated audio portion 155 has ended. As another example, the indicator manager 107A-107N can cause the corresponding client device 102A-102N to beep or vibrate when the speech-to-speech translation feature has been enabled and/or is active during the virtual meeting 122.

In some implementations, the UIs 124A-124N of client devices 102A-102N can include input features to intake information from client devices 102A-102N. In one or more examples, a user of client devices 102A-102N can provide input data (e.g., a user query, control commands, etc.) into an input feature of the UIs 124A-124N or client devices 102A-102N, for transmission to the virtual meeting platform 120, and system 100 at large. Input features of UIs 124A-124N and/or client devices 102A-102N can include space, regions, and/or elements of the UIs 124A-124N that accept user inputs. For example, input features may include visual elements (e.g., GUI elements) such as buttons, text-entry spaces, selection lists, drop-down lists, etc. For example, in some implementations, input features may include a chat box which a user of client devices 102A-102N can use to input textual data (e.g., a user query). As an illustrative example, input features can include an indication to consent to the speech-to-speech translation feature of the virtual meeting platform 120, an indication to enable the speech-to-speech translation feature (e.g., during a virtual meeting 122), and/or to indicate language preferences of the user. The client devices 102A-102N can then transmit that input data to virtual meeting platform 120, and the system 100 at large, for further processing. In other examples, input features can include a selection list, in which a user of client devices 102A-102N can input selection data, e.g., by selecting, or clicking. The client devices 102A-102N can then transmit that selection data to virtual meeting platform 120, and the system 100 at large, for further processing.

In some implementations, server 130 includes a virtual meeting manager 132. Virtual meeting manager 132 can be configured to manage a virtual meeting 122 between multiple users of virtual meeting platform 120. In some implementations, virtual meeting manager 132 can provide the UIs 124A-124N to each client device to enable users to watch and listen to each other during a virtual meeting. Virtual meeting manager 132 can also collect and provide data associated with the virtual meeting 122 to each participant of the virtual meeting 122. In some implementations, virtual meeting manager 132 can provide the UIs 124A-124N for presentation by client application 105A-105N. For example, the UIs 124A-124N can be displayed on a display device 103A-103N by a native client application 105A-105N executing on the operating system of the client device 102A-102N or the client device(s) 104. In some implementations, the virtual meeting manager 132 can determine visual items and/or visual indicators for presentation in the UI 124A-124N during a virtual meeting 122. A visual item can refer to a UI element that occupies a particular region in the UI and is dedicated to presenting a media stream 152 from a respective client device 102A-102N, 104. Such a media stream can depict, for example, a user of the respective client device while the user is participating in the virtual meeting (e.g., speaking, presenting, listening to other participants, watching other participants, etc., at particular moments during the virtual meeting), a physical conference or meeting room (e.g., with one or more participants present), a document or media content (e.g., video content, one or more images, etc.) being presented during the virtual meeting, a transcript of the audio (e.g., original audio portion 154 and/or translated audio portion 154), etc. It is appreciated that providing media streams 152 for presentation is described herein by way of example, and not limitations, noting that aspects and implementations of the present disclosure can be applied to other visual items (e.g., recorded videos) without deviating from the scope of the present disclosure. In some implementations, the virtual meeting manager 132 can determine UI features for presentation in the UI 124A-124N during a virtual meeting 122. A UI feature can refer to a UI element that occupies a particular region in the UI and is dedicated to presenting a particular notification (e.g., using a visual indicator) to a user of the respective client device 102A-102N, 104.

In some implementations, the virtual meeting manager 132 can include a media stream processor 163, a user interface (UI) manager 164, and/or a connection manager 165. The components can be combined together or separated into further components, according to a particular implementation. It should be noted that in some implementations, various components of the virtual meeting manager 132 can run on separate machines.

In some implementations, the media stream processor 163 can receive video feeds (e.g., the video feed pertaining to one or more participants of a virtual meeting) and/or audio feeds (e.g., from an audiovisual component of the client device) from the client devices 102A-102N and/or 104. The media stream processor 163 can process the audio and/or video, in order to convert the raw audio and/or video feeds received from a client device into a form that can be interpreted by an AI model. In some implementations, the media stream processor 163 can receive raw audio signals and can perform feature extraction to generate audio data that can be interpreted by an AI model. For example, the audio signal can be converted from the time domain into the frequency domain, to create a spectrogram that represents how the energy of the signal is distributed over different frequencies across time. The resulting data can be a spectrogram image, or its numerical array representation, for example. Other feature extraction methods may be used.

In some implementations, the media stream processor 163 can receive a video feed from a client device 102A-102N, 104, and can process the video feed to convert the video feed into a form that can be interpreted by an AI model. For example, the media stream processor 163 can perform frame extraction and optical flow analysis. Media stream processor 163 can break down the video into individual frames (e.g., according to the frame rate of the video feed). The optical flow analysis can capture motion between frames by analyzing pixel displacement, resulting in an optical flow vector.

In some implementations, the media stream processor 163 can receive media streams 152 from client devices 102A-102N and/or client device(s) 104. The media stream processor 163 can determine media streams 152 for presentation in the UIs 124A-124N during the virtual meeting 122. Each media stream 152 can correspond to a media stream from a client device (e.g., the media stream 152 pertaining to one or more participants of the virtual meeting 122). In some implementations, the media stream processor 163 can receive audio streams associated with the media streams 152 from the client devices (e.g., from an audiovisual component of the client devices 102A-102N).

A participant can join and participate in a virtual meeting 122 via a UI 124A presented on the display device 103A by the web browser or client application 105A. As described previously, an audiovisual component of each client device can capture images and generate video data (e.g., a media stream 152) of the captured data of the captured images. In some implementations, the client devices 102A-102N and/or client device(s) 104 can transmit the generated media stream 152 to virtual meeting manager 132. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to virtual meeting manager 132.

The UI manager 164 can provide a UI for a virtual meeting 122. The UI can include multiple regions. Each region can display a media stream 152 pertaining to one or more participants of the virtual meeting 122. The UI manager 164 can control which media stream 152 is to be displayed by providing a command to the client devices that indicates which media stream 152 is to be displayed in which region of the UI (along with the video and audio streams being provided to the client devices). For example, in response to being notified of the determined media streams 152 and/or translation audio portions 155 for presentation in the UI 124A-124N, the UI manager 164 can transmit a command causing each determined media stream 152 to be displayed in a region of the UI and/or rearranged in the UI.

The connection manager 165 can manage connections of the client devices 102A-102N, 104 to the virtual meeting 122 of the virtual meeting platform 120. In some implementations, the connection manager 165 enables a client device 102A-102N, 104 to establish a network connection to the virtual meeting platform 120. In some implementations, the connection manager 165 can monitor a connection health between a client device 102A-102N, 104 and the virtual meeting platform 120. Connection health may depend on one or more of connection latency, packet loss, packet jitter, or the like. In some implementations, the connection manager 165 can adjust connection parameters, such as a bitrate, resolution, or the like in response to a monitored connection health. For example, if the connection health is poor (e.g., there are a large number of dropped packets, high latency, etc.), the connection manager 165 may reduce a bitrate, resolution, or the like of media streams 152 transmitted to the device 102A-102N, 104. In another example, if the connection health is satisfactory, (e.g., there are a minimal number of dropped packets, low latency, etc.), the connection manager 165 may increase a bitrate, resolution, or the like of media streams 152 transmitted to the device 102A-102N, 104. In some implementations, the connection manager 165 may attempt to reestablish a connection with a device 102A-102N, 104 in the event of an unintended disconnection. In some implementations, the connection manager 165 may attempt to route the delivery of the media stream 152 to the device 102A-102N, 104 through alternative network paths based on the determined connection health.

In some implementations, a client device 102A can access the virtual meeting platform 120 through network 108 using one or more application programming interface (API) calls via platform API endpoint 129. In some implementations, virtual meeting platform 120 can include multiple platform API endpoints 129 that can expose services, functionality, or information of the virtual meeting platform 120 to one or more client devices 102A-102N. In some implementations, a platform API endpoint 129 can be one end of a communication channel, where the other end can be another system, such as a client device 102A associated with a participant or user account. In some implementations, the platform API endpoint 129 can include or be accessed using a resource locator, such a universal resource identifier (URI), universal resource locator (URL), of a server or service. The platform API endpoint 129 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 129.

In some implementations, the platform API endpoint 129 can function as a computer interface through which access requests are received and/or created. In some implementations, the platform API endpoint 129 can include a platform API whereby external entities or systems can request access to services and/or information provided by the virtual meeting platform 120. The platform API can be used to programmatically obtain services and/or information associated with a request for services and/or information.

In some implementations, the API of the platform API endpoint 129 can be any suitable type of API such as a REST (Representational State Transfer) API, a GraphQL API, a SOAP (Simple Object Access Protocol) API, and/or any suitable type of API. In some implementations, the virtual meeting platform 120 can expose through the API, a set of API resources which when addressed can be used for requesting different actions, inspecting state or data, and/or otherwise interacting with the virtual meeting platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the virtual meeting platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some implementations, any element, such as server 130, server 140, and/or data store 106 may include a corresponding API endpoint for communicating with APIs.

The system 100 can include one or multiple artificial intelligence (AI) model(s), e.g., AI model(s) 141. AI model(s) can also be referred to as a “machine learning (ML) model” herein. An AI model can include a discriminative machine learning model (also referred to as “discriminative AI model” herein), a generative machine learning model (also referred to as “generative AI model” herein), and/or other AI or ML model(s).

In some implementations, a discriminative AI model can model a conditional probability of an output for given input(s). A discriminative AI model can learn the boundaries between different classes of data to make predictions on new data. In some implementations, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some implementations, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data synthesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

In some implementations, a first AI model 141 of AI models 141 may be trained to identify a language of media and/or audio. For example, the first AI model 141 may be trained to identify multiple languages of media and/or audio provided as input, and may provide a corresponding confidence level for each identified language. In some implementations, the first AI model 141 may be trained to identify a first portion of the media and/or audio that is in a first language, and a second portion of the media and/or audio that is in a second language. For example, the first AI model 141 may be trained to provide an indication of where in the media and/or audio the language changes from the first language to the second language). The indication of where the language changes may be a timestamp, for example. The first AI model 141 can be a model that is trained on data generated by a training set generator. The training set generator may be capable of generating training data (e.g., a set of training inputs and a set of target outputs) to train the first AI model 141. In some implementations, the training set generator can generate the training data based on various data (e.g., stored at data store 106 or another data store connected to system 100 via the network 108 or via another network). The data store 106 can store metadata associated with the training data.

In some implementations, a second AI model 141 of AI models 141 may be trained to translate media in a first language into media in a second language. For example, the second AI model 141 may be trained to translate text data in a first language into text data in a second language. In another example, the second AI model 141 may be trained to translate audio or speech data in a first language into audio or speech data in a second language. The second AI model 141 can be a model that is trained on data generated by a training set generator. The training set generator may be capable of generating training data (e.g., a set of training inputs and a set of target outputs) to train the second AI model 141. In some implementations, the training set generator can generate the training data based on various data (e.g., stored at data store 106 or another data store connected to system 100 via the network 108). The data store 106 can store metadata associated with the training data.

In some implementations, one or more of the AI models 141 are trained on training sets by a training engine. Each AI model 141 (also referred to “machine learning model” or “artificial intelligence (AI) model” herein) may refer to the model artifact that is created by the training engine using the training data that includes training inputs (e.g., features) and corresponding target outputs (correct answers for respective training inputs) (e.g., labels). The training engine may find patterns in the training data that map the training input to the target output (the answer to be predicted) and provide each AI model 141 that captures these patterns. Each of the AI models 141 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. AI model 141 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some implementations, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some implementations, one or more of the AI models 141 can be a generative AI model. A generative AI model is an AI model which can generate new, original data. An AI model 141 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some implementations, one or more of the AI models 141 can be a generative large language model (LLM). In some implementations, one or more of the AI models 141 can be a large language model that has been pre-trained on a large corpus of data so as to process, analyze, and generate human-like text based on given input.

In some implementations, one or more of the AI models 141 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some implementations, an AI model 141, such as an LLM, can use an encoder-decoder architecture including one or more self-attention mechanisms, and one or more feed-forward mechanisms. In some implementations, the AI model 141 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. An AI model 141 can also utilize the previously discussed deep learning techniques, including recurrent neural networks (RNNs), convolutional neural networks (CNNs), or transformer networks.

In some implementations, one or more of the AI models 141 can be a multi-modal generative AI model, such as a Visual-Language Model (VLM). In some implementations, the AI model 141 can be a VLM that has been pre-trained on a large corpus of data (e.g., textual data and image data) so as to process, analyze, and generate human-like text and/or image data based on given input (e.g., image data and/or natural language text).

In some implementations, training a generative AI model can include providing training input to an AI model 141, and the AI model 141 can produce one or more training outputs. The one or more training inputs can be compared to one or more evaluation metrics. An evaluation metric can refer to a measure used to assess the output (e.g., training output(s)) of an AI model, such as an AI model 141. In some implementations, the evaluation metric can be specific to the task and/or goals of the AI model. Based on the comparison, one or more parameters and/or weights of the AI model 141 can be adjusted (e.g., backpropagation based on computed loss). In some implementations, and for example, the one or more training outputs can be compared to an evaluation metric such as a ground truth (e.g., target output, such as a correct or better answer). In some implementations and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some implementations, a validation engine may be capable of validating an AI model 141 using a corresponding set of features of a validation set from the training set generator. In some implementations, the validation engine may determine an accuracy of each of the trained generative models, such as AI model 141 (e.g., accuracy of the training output) based on the corresponding sets of features of the validation set. The validation engine may discard a trained AI model 141 that has an accuracy that does not meet a threshold accuracy. In some implementations, a selection engine not shown) may be capable of selecting an AI model 141 that has an accuracy that meets a threshold accuracy. In some implementations, the selection engine may be capable of selecting the trained AI model 141 that has the highest accuracy of the trained generative models (e.g., AI model 141).

A testing engine may be capable of testing a trained AI model 141 using a corresponding set of features of a testing set from the training engine 141. For example, a first trained AI model 141 that was trained using a first set of features of the training set may be tested using the first set of features of the testing set. The testing engine may determine a trained AI model 141 that has the highest accuracy of all of the trained AI models based on the testing sets.

In some implementations, an AI model 141 can be trained on a corpus of data, such as textual data and/or image data. In some implementations, the AI model 141 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The AI model 141 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the AI model 141 is to be adapted. In some implementations, AI model 141 may include one or more pre-trained models or adapted models.

In some implementations, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some implementations, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some implementations, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.” In some implementations, preprocessing can include data embedding. Data embedding

can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some implementations embedding data can represent original data (e.g., word, phrase, document, or entity) as a vector in vector space, such as continuous vector space. Each element (e.g., dimension) of the vector can correspond to a feature or property of the original data (e.g., object). In some implementations, the size of the embedding vector (e.g., embedding dimension) can be adjusted during model training. In some implementations, the embedding dimension can be fixed to help facilitate analysis and processing of data by machine learning models.

In some implementations, the translation engine 150 provides an input to a first AI model of the AI models 141. The first AI model provides an indication of the language of the input, which is obtained by translation engine 150. In some implementations, the translation engine 150 provides an input to a second AI model of the AI models 141. The second AI model generates an output, which is obtained by the translation engine 150. In some implementations, the server 140 includes the translation engine 150 that provides an input (e.g., media stream, audio stream, media portion, audio portion, text data, language preferences, language identification, etc.) as input to the trained model (e.g., AI models 141) and runs the trained model on the input to provide and/or generate one or more outputs.

In some implementations, confidence data can include or indicate a level of confidence that a particular output (e.g., output(s)) corresponds to one or more inputs of the machine learning model (e.g., trained machine learning model). In one example, the level of confidence is a real number between 0 and 1 inclusive, where O indicates no confidence that output(s) corresponds to a particular one or more inputs and 1 indicates absolute confidence that the output(s) corresponds to a particular one or more inputs. In some implementations, confidence data can be associated with inference using a machine learning model.

In some implementations, a machine learning model, such as AI models 141, may be (or may correspond to) one or more computer programs executed by processor(s) of server 140 and/or server 130. In other implementations, a machine learning model may be (or may correspond to) one or more computer programs executed across a number or combination of servers. For example, in some implementations, machine learning models may be hosted on the cloud, while in other implementations, these machine learning models may be hosted and perform operations using the hardware of a client device 102A-102N. In some implementations, the machine learning models may be a self-hosted machine learning model, while in other implementations, machine learning models may be external machine learning models accessed by an API.

In some implementations, virtual meeting platform 120, server 130, and/or server 140 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. Virtual meeting platform 120 can also include a website (e.g., a webpage) or application back-end software that can be used to enable a user to connect with other users via the virtual meeting 122.

It should be noted that in some other implementations, the functions of server 130, server 140, and/or virtual meeting platform 120 can be provided by a fewer number of machines. For example, in some implementations, server 130 and/or server 140 can be integrated into a single machine, while in other implementations, server 130 and/or server 140 can be integrated into multiple machines. In addition, in some implementations, server 130 and/or server 140 can be integrated into virtual meeting platform 120.

In general, functions described in implementations as being performed by virtual meeting platform 120, server 130, and/or server 140 can also be performed by the client devices 102A-N and/or client device(s) 104 in other implementations, if appropriate. In addition, the functionality attributed to a particular component can be performed by different or multiple components operating together. In some implementations, the functions of notification manager 107A-107N can be performed by server 130, server 140, and/or by virtual meeting platform 120. Virtual meeting platform 120, server 130, and/or server 140 can also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call, conference call, or virtual meeting between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” or “participant” being an entity controlled by a set of users and/or an automated source such as a system or platform. For example, a set of individual users federated as a community in a social network can be considered a “user.” In another example, an automated consumer can be an automated ingestion pipeline, such as a topic channel, of the virtual meeting platform 120.

In situations in which the systems discussed here collect personal information about users, or can make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130, 140 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120, server 130, and/or server 140.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities.

Prior to the system enabling collection of user information (e.g., media stream 152, audio data, language preferences, consent to enable the speech-to-speech translation feature, etc.), a user may be provided with controls allowing the user to make an election as to both if and when the system may enable such collection. For in-room participants, clear and conspicuous information regarding the data collection may be provided before their participation.

In some implementations, users may be informed of the security measures in place to protect collected data, such as encryption prior to being stored. Information regarding how long the collected data may be retained and the procedures for their removal may also be provided. Users may be informed of their options regarding their biometric data. Contact information for privacy-related questions may be made available. Methods of providing such information may include in-room displays or a companion application for in-room participants, and the platform user interface for remote participants.

In some implementations, the system 100 may obtain an affirmative indication from in-room participants prior to collecting user data. Participants may be informed of their ability to withdraw their consent and may be provided with mechanisms to do so, such as disabling data collection devices (e.g., cameras, microphones, etc.) or using a user interface control. The consequences of withdrawing consent may be clearly communicated.

Data describing user speech data may be treated in one or more ways before it is stored or used, so that personally identifiable information is removed. For example, a user's identity may be treated so that no personally identifiable information can be determined for the user. Access to stored user speech and/or audio data may be controlled to limit which components and personnel can access it.

The system may be designed to align with privacy considerations. Where technically viable, processing collected user data may occur locally on the client device to reduce server-side processing. Measures to reduce the risk of unintentionally capturing and processing personal and/or biometric data of individuals not participating in the meeting may be implemented. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data.

FIGS. 2A, 2B, and 2C illustrate examples of virtual meeting UI 200 presented on a client device (e.g., client devices 102A-102N) during a virtual meeting (e.g., virtual meeting 122), in accordance with at least one embodiment of the present disclosure. In some embodiments, UI 200 can be generated by the virtual meeting manager 132 of FIG. 1 for presentation at a client device (e.g., client devices 102A-102N, 104). Accordingly, UI 200 can be generated by one or more processing devices of the server 130 of FIG. 1. In some embodiments, UI 200 can be generated and/or modified by indicator manager 107A-107N of FIG. 1.

As illustrated in FIG. 2A, UI 200 provides, for presentation to one or more users, a visual representation of a video stream 202 from a first client device of a first participant, a visual representation of a video stream 204 from a second client device of a second participant, and a visual representation of a video stream 206 from a third client device of a third participant. The second participant (represented by video stream 204) can be, for example, the user of the client device displaying UI 200. UI 200 can include tool panel 208, which can include a set of buttons to perform one or more actions related to the virtual meeting. The set of buttons can include, for example, a button to modify the video (e.g., turn the video feed on/off, select a background, etc.), a button to modify the audio (e.g., a mute button, a volume control button, an audio feed source button, etc.), a closed captions button (e.g., to turn on/off the closed captions during the virtual meeting), an emoji button (e.g., to select one or more emojis for display), a presentation button (e.g., to allow a user to present during the virtual meeting), a hand raise button, a leave button (e.g., a button to leave the virtual meeting, to end the virtual meeting, etc.), and so on.

In some embodiments, UI 200 can also include peninsula 210, which can display one or more badges that are used to convey, for example, one or more types of actions that are performed during the virtual meeting, one or more features active during the virtual meeting, one or more features enabled during the virtual meeting, one or more features available but not yet enabled or inactive during the virtual meeting, and so on.

In some embodiments, peninsula 210 can include a universal translate badge 230. In some implementations, the universal translate badge 230 can be greyed out if the speech-to-speech feature translation is not enabled for the participant viewing UI 200, or if the speech-to-speech translation feature is disabled for the entire virtual meeting. In some implementations, the universal translate badge 230 can be in color if the speech-to-speech translation feature is enabled for the participant and/or for the virtual meeting. In some implementations, a user can interact with the universal translate badge 230. For example, a user can hover over the universal translate badge 230, which will cause additional options to appear on UI 200.

In some implementations, UI 200 can represent a moment during the virtual conference during which the user represented by video stream 206 is the speaker. For example, the waveform indicator 222 can be displayed in a region overlapping the tile of the current speaker. If the audio of the current speaker is being actively translated, an active speaker tile indicator 220 can be displayed in a region overlapping the tile of the current speaker. The active speaker tile indicator 220 can specify the source language, for example, by including text such as “Translating from English” (if English is the source language). This text may be used if the audio is being translated for the user of the client device displaying UI 200 (e.g., if the user of the client device displaying UI 200 does not understand English and is listening to a translation of the audio). The active speaker tile indicator 220 can notify that the active speaker is being translated by including text such as “Translating for others.” This text may be used if the audio is not being translated for the user of the client device displaying UI 200 (e.g., if the user of the client device displaying UI understands English and thus is not receiving a translation of the audio, but rather is listening to the original audio of the speaker). The text displayed in the active speaker tile indicator 220 is not limited to these examples.

The active speaker tile indicator 220 is displayed as long playback of a translation of the speaker's audio is ongoing. Thus, even if the user of the client device displaying UI 200 may not be hearing a translation of the audio, or even if the translation of the audio is finished for the user of client device displaying UI 200, the active speaker tile indicator 220 notifies the user of the client device displaying UI 200 that playback of a translation of the audio is ongoing. The active speaker tile indicator 220 can be removed from UI 220 once playback of all translations of the speaker's audio have ended.

As illustrated in FIG. 2B, UI 240 represents a moment during the virtual meeting when the second participant (represented by video stream 204) is the active speaker, as indicated by the waveform indicator 222 is displayed in a region overlapping the tile of the current speaker. In UI 240, rather than provide an active speaker tile indicator, UI 240 includes a speaker notification indicator 218. In some implementations, the speaker notification indicator 218 can be an extension of the tool bar 208. In some implementations, the speaker notification indicator 218 can be displayed along the peninsula 210, or in another region of UI 240. The speaker notification indicator 218 can include text such as “You are being translated,” or text to that effect, to notify the speaker that their audio is actively being translated. The speaker notification indicator 218 can be displayed for as long as playback of the translated audio is ongoing.

As illustrated in FIG. 2C, UI 260 includes a global translation status indictor 232. The global translation status indicator 232 can include a persistent or temporary “info ticker” style (or similar style) notification that informs all participants when real-time speech-to-speech translation is active in the virtual meeting. The global translation status indicator 232 can include text such as “Translation is active” or “AI is translating in this call” or similar text. In some implementations, the global translation status indicator 232 can be visible to all participants of the virtual meeting, regardless whether the participant has enabled speech-to-speech translation or whether the audio is being translated for the participant.

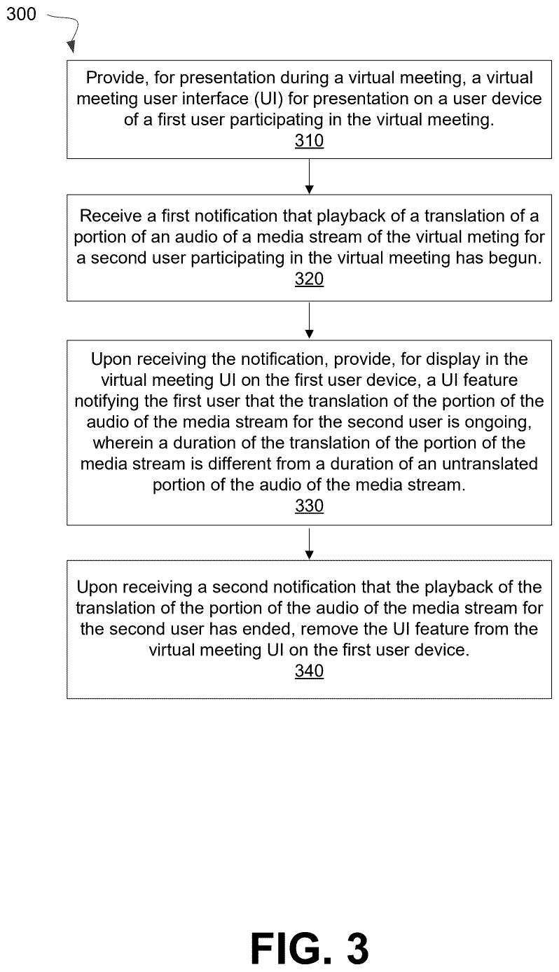

FIG. 3 is a flow diagram of an example method 300 for providing translation activity indicators during a virtual meeting, according to at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of client devices 102A-102N, 104, and/or virtual meeting platform 120 of FIG. 1. In other implementations, some or all of the operations of method 300 can be performed by one or more components of server device(s) 130, 140, and/or platform 120 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 310, processing logic provides, for presentation during a virtual meeting, a virtual meeting user interface (UI) for presentation on a user device (e.g., client device 102A-102N, 104 of FIG. 1) of a first user participating in the virtual meeting (e.g., the virtual meeting 122 described with respect to FIG. 1). An example UI is described with respect to FIGS. 2A-2C.

At block 320, processing logic receives a first notification that playback of a translation of a portion of an audio of a media stream of the virtual meeting for a second user participating in the virtual meeting has begun. In some implementations, the translation can be generated using artificial intelligence, e.g., as described with respect to FIG. 1 and/or FIG. s 4A-B.

At block 330, upon receiving the notification, processing logic provides, for display in the virtual meeting UI on the first user device, a UI feature notifying the first user that the translation of the portion of the audio of the media stream for the second user is ongoing, wherein a duration of the translation of the portion of the media stream is different from a duration of an untranslated portion of the audio of the media stream.

In some implementations, if the first user is the current speaker, the UI feature can indicate to the first user that their speech is being translated. Thus, responsive to determining that the portion of the audio corresponds to the first user device, the UI feature can indicate to the first user that the first user is being translated. An example of the UI feature is described with respect to UI element 218 of FIG. 2B.

In some implementations, processing logic can identify a first language of the untranslated portion of the audio and can identify a second language of the translation of the portion of the audio. The UI feature can then include a notification to the first user of at least one of the first language or the second language. As an illustrative example, the UI feature can notify the first user that the audio is being translated for them from the first language (e.g., from the source language), e.g., by displaying text such as “Translating from English.” An example of the UI feature is described with respect to UI element 220 of FIG. 2A. As another illustrative example, the UI feature can notify the first user that the audio is being translated for another participant to the second language (e.g., the target language), e.g., by displaying text such as “Translating to Spanish.” As another illustrative example, the UI feature can notify the first user that audio is being translated from the first language (e.g., the source language) to the second language (e.g., the target language), by displaying text such as “Translating from English to Spanish.”

In some implementations, the UI feature can indicate the duration of the translated portion of the audio of the media stream. For example, the UI feature can visually represent the progression of the playback of the translated audio, updating dynamically to reflect the elapsed portion of the duration. The UI feature can convey the passage of time through changes in appearance, such as shifting colors, progressing fill level, increasing opacity, a solid line that moves toward a target, a gradually forming border around an already-displayed UI feature, and so on.

At block 340, upon receiving a second notification that the playback of the translation of the portion of the audio of the media stream for the second user has ended, processing logic removes the UI feature from the virtual meeting UI on the first user device.

In some implementations, in response to determining that a real-time translation feature of a virtual meeting platform of the virtual meeting is enabled for the virtual meeting, processing logic provides, for display in the virtual meeting UI on the first user device, a second UI feature notifies the first user that the real-time translation feature is enabled. In some implementations, an example of the second UI feature is described with respect to element 230 of FIG. 2A. In response to determining that the real-time translation feature is enabled and that the translation is active during the virtual meeting, processing logic modifies the second UI feature to indicate the translation is active. In some implementations, an example of the second UI feature is described with respect to element 232 of FIG. 2C.

In some implementations, in response to receiving a user interaction with the second UI feature, processing logic provides, for display in the virtual meeting UI on the first user device, a third UI feature indicating one or more languages of the translation of the portion of the audio of the media stream.

In some implementations, the UI feature can be displayed in a region of the virtual meeting UI that overlaps with a tile of the active speaker. Thus, processing logic identifies a user of a plurality of users participating in the virtual meeting. The identified user corresponds to the portion of the audio of the media stream. Processing logic identifies a tile in the virtual meeting UI. The tile corresponds to the user, and the UI feature notifying the first user that the translation is provided for display in a UI region overlapping the identified tile. An example of the UI feature overlapping the tile of the speaker is described with respect to UI element 220 of FIG. 2A.

FIG. 4A illustrates a schematic block diagram for an example artificial intelligence (AI) training subsystem 400 to train one or more AI models 430A-M, in accordance with some implementations of the present disclosure. As illustrated in FIG. 4A, the AI training subsystem 400 can include a training subsystem 410, which can include a training data engine 412, a training engine 414, a validation engine 416, a selection engine 418, or a testing engine 420. The AI training subsystem 400 can include one or more AI models 430A-M.

In one implementation, an AI model 430A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN can include adjusting the weights or other features of the ANN based on an output produced by the ANN during training.

An ANN can include, for example, a convolutional neural network (CNN), recurrent neural network (RNN), or a deep neural network. A CNN, a specific type of ANN, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). A deep network can include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) can include a hierarchy of layers, where the different layers learn different levels of representations that correspond to different levels of abstraction. In deep learning, each level learns to transform its input data into a slightly more abstract and composite representation.

In some implementations, an AI model 430A-M is an AI model that has been trained on a corpus of data. For example, the AI model 430A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 430A-M while training can be ranked by a user, according to a variety of factors, including accuracy, helpfulness, veracity, acceptability, or any other metric useful in the fine-tuning portion of training. In this manner, the AI model 430A-M can learn to favor these and any other factors relevant to users when generating a response. Further details regarding training are provided below.

In some implementations, an AI model 430A-M includes one or more pre-trained models, or fine-tuned models. In a non-limiting example, in some implementations, the goal of the “fine-tuning” can be accomplished with a second, or third, or any number of additional models. For example, the outputs of the pre-trained model can be input into a second AI model 430A-M that has been trained in a similar manner as the “fine-tuned” portion of training above. In such a way, two more AI models 430A-M can accomplish work similar to one model that has been pre-trained, and then fine-tuned.

In some implementations, the training subsystem 410 manages the training and testing of an AI model 430A-M. The training data engine 412 can generate training data. For example, in the present disclosure the training data can include video and/or audio content. The audio content of the training data can include audio streams of participants participating in a virtual meeting. The video content of the training data can include video streams of participants participating in a virtual meeting. In some implementations, the audio of the video streams can be extracted from the video streams and used as audio content of the training data. In some embodiments, the audio training data can include a recording of a person speaking (e.g., an audio recording and/or a video recording). In some embodiments, the audio content is included in the video content. The audio data can include one or more phonemes, word fragments, words, sentences, or other portions of speech. Each piece of audio training data can include a corresponding target output that includes an indication of the language of the piece of audio. The training engine 414 can use the audio content training data to train one or more of AI model 430A-M configured to identify a spoken language of the audio, and/or one or more AI models 430A-M to generate an audio translation of the audio from a first language to a second language (an indication of the second language can be pe provided in the audio content training data The video content can include video content of a participant speaking, presenting, sharing documents, images, etc., during a virtual meeting. Each piece of video training data can include a target output that includes an indication of the language of the audio portion of the video. The training engine 514 can use the video content training data to train one or more of AI models 530A-M configured to identify a spoken language of the audio, and/or one or more of AI models 530A-M to generate a translation of the audio from a first language to a second language (an indication of the second language can be provided in the audio content training data).

In an illustrative example, the training data engine 412 can initialize a training set T to null (e.g., {}). The training data engine 412 can add the training data to the training set T and can determine whether training set T is sufficient for training a AI model 430A-M. The training set T can be sufficient for training the AI model 430A-M if the training set T includes a threshold amount of training data, in some implementations. In response to determining that the training set T is not sufficient for training, the training data engine 412 can identify additional data to use as training data. In response to determining that the training set T is sufficient for training, the training data engine 412 can provide the training set T to the training engine 414.

The training engine 414 can train an AI model 430A-M using the training data (e.g., training set T). The AI model 430A-M can refer to the model artifact that is created by the training engine 414 using the training data, where such training data can include training inputs and, in some implementations, corresponding target outputs. The training engine 414 can input the training data into the AI model 430A-M so that the AI model 430A-M can find patterns in the training data and configure itself based on those patterns.

Where the AI model 430A-M uses supervised learning, the training engine 414 can assist the AI model 430A-M in determining whether the AI model 430A-M maps the training input to the target output. Where the AI model 430A-M uses unsupervised learning, the training engine 414 can input the training data into the AI model 430A-M The AI model 430A-M can configure itself based on the input training data, but since the training data may not include a target output, the training engine 414 may not assist the AI model 430A-M in determining whether the AI model 430A-M provided a correct output during the training process.

The validation engine 416 can be capable of validating a trained AI model 430A-M using a corresponding set of features of a validation set from the training data engine 412. The validation engine 416 can determine an accuracy of each of the trained AI models 430A-M based on the corresponding sets of features of the validation set. Where the training data may not include a target output, validating a trained AI model 430A-M can include obtaining an output from the AI model 430A-M and providing the output to another entity for evaluation. The other entity can include another AI model 430A-M configured to evaluate the output of the AI model 430A-M that is undergoing training. The other entity can include a human. The validation engine 416 can discard a trained AI model 430A-M that has an accuracy that does not meet a threshold accuracy or that otherwise fails evaluation. In some implementations, the selection engine 418 is capable of selecting a trained AI model 430A-M that has an accuracy that meets a threshold accuracy. In some implementations, the selection engine 418 can be capable of selecting the trained AI model 430A-M that has the highest accuracy of multiple trained AI models 430A-M. In some implementations, the selection engine 418 receives input from another AI model 430A-M or a human and can select a trained AI model 430A-M based on the input.

The testing engine 420 can be capable of testing a trained AI model 430A-M using a corresponding set of features of a testing set from the training data engine 412. For example, a first trained AI model 430A that was trained using a first set of features of the training set can be tested using the first set of features of the testing set. The testing engine 420 can determine a trained AI model 430A-M that has the highest accuracy or other evaluation of all of the trained AI models 430A-M based on the testing sets.

In some implementations, the training engine 414 trains an AI model 430A. The AI model 430A can identify a language of audio provided as input. The training data engine 412 can generate training data that includes one or more identified languages. In some implementations, each identified language can have a corresponding confidence score. The confidence score can represent the likelihood that the input audio is in the identified language. The training engine 414 can cause the AI model 430A to undergo an AI model training process using the training data. The AI model 430A can undergo a validation and testing process using the validation engine 416 and testing engine 420.

In some implementations, the training engine 414 trains an AI model 430B. The AI model 430B can generate an audio translation from a first language (e.g., identified by AI model 430A or provided as input), to a second language (e.g., as indicated by input). The training data engine 412 can generate training data that includes translations from the first language to the second language. In some implementations, each translation can have a corresponding confidence score that represents the accuracy of the translation. The training engine 414 can cause the AI model 430B to undergo an AI model training process using the training data. The AI model 430B can undergo a validation and testing process using the validation engine 416 and testing engine 420.

In some implementations, the AI training subsystem 400 is part of the server 140, 130, the platform 120, or the virtual meeting manager 132. Alternatively, the AI training subsystem 400 can be part of another server, system, sub-system, or it can be an independent system. In some implementations, the AI training subsystem 400 provides the trained one or more AI models 430A-M to the virtual meeting manager 132.

FIG. 4B illustrates a schematic block diagram for an AI inference subsystem 426 of a virtual meeting platform 120, that the translation engine 150 can use to perform one or more operations, in accordance with at least one embodiment of the present disclosure. The AI inference subsystem 426 can include one or more AI models 430A-M. The one or more AI models 430A-M can include one or more of the AI models 430A-M trained by the AI training subsystem 400, as described with respect to FIG. 4A.

In some implementations, the AI inference subsystem 426 includes an AI input/output component 440. The AI input/output component 440 can be configured to feed data as input to an AI model 430A-M, e.g., one or more video feeds received from client devices 102A-102N, 104, and/or one or more media stream received from client devices 102A-102N, 104, and/or profile data 156. The AI input/output component 440 can be configured to obtain one or more outputs from the one or more AI models 430A-M and provide the one or more outputs to the translation engine 150. The output(s) can include an indication of a spoken language and/or a generated translation of the audio in a different language. In some implementations, the output(s) have a corresponding confidence score that reflects a probability of accuracy.

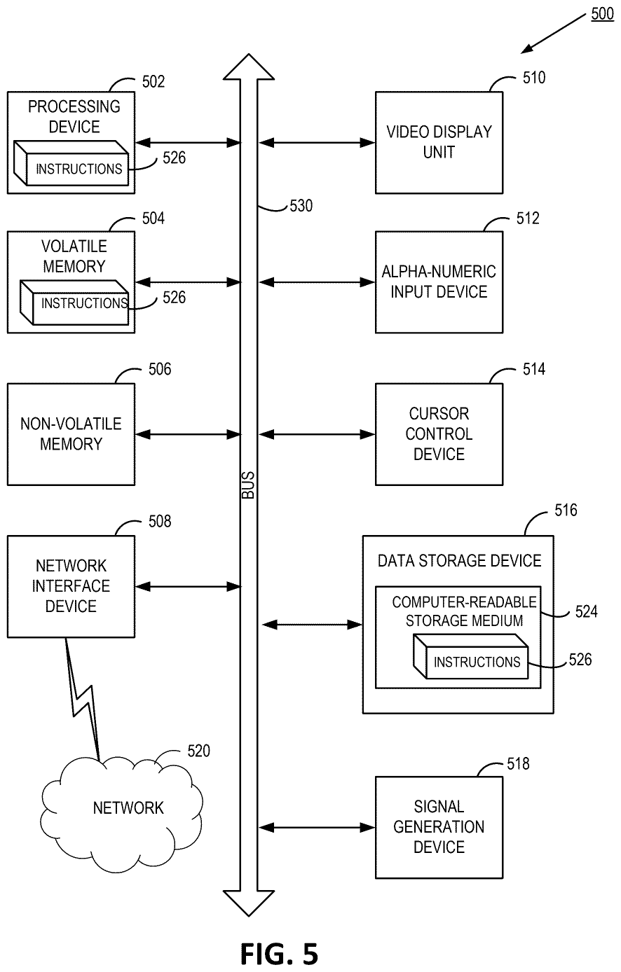

FIG. 5 is a block diagram illustrating an exemplary computer system 500, in accordance with at least one embodiment of the present disclosure. The computer system 500 can correspond to server device 130, server device 140, platform 120, and/or client devices 102A-102N, 104 in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 506 (e.g., non-volatile memory, flash memory, static random access memory (SRAM), etc.), and a data storage device 516, which communicate with each other via a bus 530.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for providing translation activity indicators during a virtual meeting) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 526 (e.g., for providing translation activity indicators during a virtual meeting) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for providing translation activity indicators during a virtual meeting. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
providing, for presentation during a virtual meeting, a virtual meeting user interface (UI) for presentation on a first user device of a first user participating in the virtual meeting;
receiving a first notification that playback of a translation of a portion of an audio of a media stream of the virtual meeting for a second user participating in the virtual meeting has begun;
upon receiving the first notification, providing, for display in the virtual meeting UI on the first user device, a UI feature notifying the first user that the translation of the portion of the audio of the media stream for the second user is ongoing, wherein a first duration of the playback of the translation of the portion of the audio of the media stream is different from a second duration of playback of an untranslated portion of the audio of the media stream; and
upon receiving a second notification that the playback of the translation of the portion of the audio of the media stream for the second user has ended, removing the UI feature from the virtual meeting UI on the first user device.

2. The method of claim 1, wherein, responsive to determining that the portion of the audio corresponds to audio captured by the first user device, the UI feature indicates to the first user that speech of the first user is being translated for one or more other users in the virtual meeting.

3. The method of claim 1, further comprising:
identifying a first language of the untranslated portion of the audio and a second language of the translation of the portion of the audio, wherein the UI feature notifies the first user of at least one of the first language or the second language.

4. The method of claim 1, wherein the UI feature indicates the first duration of the playback of the translation of the portion of the audio of the media stream.

5. The method of claim 1, further comprising:
responsive to determining that a real-time translation feature of a virtual meeting platform of the virtual meeting is enabled for the virtual meeting, providing, for display in the virtual meeting UI on the first user device, a second UI feature notifying the first user that the real-time translation feature is enabled.

6. The method of claim 5, further comprising:
responsive to determining that the real-time translation feature is enabled and that the translation is active during the virtual meeting, modifying the second UI feature to indicate the translation is active.

7. The method of claim 5, further comprising:
responsive to receiving a user interaction with the second UI feature, providing, for display in the virtual meeting UI on the first user device, a third UI feature indicating one or more languages of the translation of the portion of the audio of the media stream.

8. The method of claim 1, further comprising:
identifying a user of a plurality of users participating in the virtual meeting, wherein a user device of the user corresponds to the portion of the audio of the media stream; and
identifying a tile in the virtual meeting UI, wherein the tile corresponds to the user, and wherein the UI feature notifying the first user of the translation is provided for display in a UI region overlapping the tile.

9. A system comprising:
a memory device; and
a processing device coupled to the memory device, the processing device to perform operations comprising:
providing, for presentation during a virtual meeting, a virtual meeting user interface (UI) for presentation on a first user device of a first user participating in the virtual meeting;
receiving a first notification that playback of a translation of a portion of an audio of a media stream of the virtual meeting for a second user participating in the virtual meeting has begun;
upon receiving the first notification, providing, for display in the virtual meeting UI on the first user device, a UI feature notifying the first user that the translation of the portion of the audio of the media stream for the second user is ongoing, wherein a first duration of the playback of the translation of the portion of the audio of the media stream is different from a second duration of playback of an untranslated portion of the audio of the media stream; and
upon receiving a second notification that the playback of the translation of the portion of the audio of the media stream for the second user has ended, removing the UI feature from the virtual meeting UI on the first user device.

10. The system of claim 9, wherein, responsive to determining that the portion of the audio corresponds to audio captured by the first user device, the UI feature indicates to the first user that speech of the first user is being translated for one or more other users in the virtual meeting.

11. The system of claim 9, wherein the operations further comprise:
identifying a first language of the untranslated portion of the audio and a second language of the translation of the portion of the audio, wherein the UI feature notifies the first user of at least one of the first language or the second language.

12. The system of claim 9, wherein the UI feature indicates the first duration of the playback of the translation of the portion of the audio of the media stream.

13. The system of claim 9, wherein the operations further comprise:
responsive to determining that a real-time translation feature of a virtual meeting platform of the virtual meeting is enabled for the virtual meeting, providing, for display in the virtual meeting UI on the first user device, a second UI feature notifying the first user that the real-time translation feature is enabled.

14. The system of claim 13, wherein the operations further comprise:
responsive to determining that the real-time translation feature is enabled and that the translation is active during the virtual meeting, modifying the second UI feature to indicate the translation is active.

15. The system of claim 13, wherein the operations further comprise:
responsive to receiving a user interaction with the second UI feature, providing, for display in the virtual meeting UI on the first user device, a third UI feature indicating one or more languages of the translation of the portion of the audio of the media stream.

16. The system of claim 9, wherein the operations further comprise:
identifying a user of a plurality of users participating in the virtual meeting, wherein a user device of the user corresponds to the portion of the audio of the media stream; and
identifying a tile in the virtual meeting UI, wherein the tile corresponds to the user, and wherein the UI feature notifying the first user of the translation is provided for display in a UI region overlapping the tile.

17. A non-transitory computer readable storage medium comprising instructions for a server that, when executed by a processing device, cause the processing device to perform operations comprising:
providing, for presentation during a virtual meeting, a virtual meeting user interface (UI) for presentation on a first user device of a first user participating in the virtual meeting;
receiving a first notification that playback of a translation of a portion of an audio of a media stream of the virtual meeting for a second user participating in the virtual meeting has begun;
upon receiving the first notification, providing, for display in the virtual meeting UI on the first user device, a UI feature notifying the first user that the translation of the portion of the audio of the media stream for the second user is ongoing, wherein a first duration of the playback of the translation of the portion of the audio of the media stream is different from a second duration of playback of an untranslated portion of the audio of the media stream; and
upon receiving a second notification that the playback of the translation of the portion of the audio of the media stream for the second user has ended, removing the UI feature from the virtual meeting UI on the first user device.

18. The non-transitory computer readable storage medium of claim 17, wherein, responsive to determining that the portion of the audio corresponds to audio captured by the first user device, the UI feature indicates to the first user that the first user is being translated, and wherein the UI feature indicates the first duration of the playback of the translation of the portion of the audio of the media stream.

19. The non-transitory computer readable storage medium of claim 17, further comprising:
responsive to determining that a real-time translation feature of a virtual meeting platform of the virtual meeting is enabled for the virtual meeting, providing, for display in the virtual meeting UI on the first user device, a second UI feature notifying the first user that the real-time translation feature is enabled;
responsive to determining that the real-time translation feature is enabled and that the translation is active during the virtual meeting, modifying the second UI feature to indicate translation is active; and
responsive to receiving a user interaction with the second UI feature, providing, for display in the virtual meeting UI on the first user device, a third UI feature indicating one or more languages of the translation of the portion of the audio of the media stream.

20. The non-transitory computer readable storage medium of claim 17, further comprising:
identifying a user of a plurality of users participating in the virtual meeting, wherein a user device of the user corresponds to the portion of the audio of the media stream; and
identifying a tile in the virtual meeting UI, wherein the tile corresponds to the user, and wherein the UI feature notifying the first user of the translation is provided for display in a UI region overlapping the identified tile.
